(19) United States
(12) Patent Application Publication
(10) Pub. No.: US 2008/0267354 A1
(43) Pub. Date: Oct. 30, 2008

(54) High-Dose X-Ray Tube

(75) Inventors: Kurt Holm, Baden (CH); Lars-Ola Nilsson, Berne (CH)

Correspondence Address: REISING, ETHINGTON, BARNES, KISSELLE, P.C., P O BOX 4390, TROY, MI, 48099-4390, US

(73) Assignee: COMET HOLDING AG., FLAMATT (CH)

(21) Appl. No.: 11/596,693

(22) PCT Filed: May 19, 2004
(86) PCT No.: PCT/EP04/50866

§ 371 Date: Nov. 16, 2006

(30) Foreign Application Priority Data
May 22, 2003 (CH) 2003-0911/03

(51) Int. Cl. H01J 35/06

(52) U.S. Cl. 378/122

(57) ABSTRACT

The invention relates to an X-ray tube (11) with a cathode that emits electrons (e−) into an interior chamber (40) that is under vacuum, and with a target (31, 32), configured as an anode, for generating high-dose X-radiation (γ), the cathode comprising at least one cold cathode (21, 22, 23) based on an electron (e−) emitting material having a field-enhancing structure (70). The invention especially relates to an X-ray tube (11) having a cold cathode (21, 22, 23) that comprises at least one support layer (201) for holding the electron (e−) emitting material, the emission area of the cold cathode (21, 22, 23) being defined by the shape of the support layer (201).

This invention relates to an X-ray tube and an electron beam gun for high dose rates, with an electron (e⁻)-emitting cathode, in particular for large-surface irradiation of objects having diverse geometry, and for use of the X-ray tube for sterilization, as well as to the use of the electron beam gun for sterilization, for drying ink or respectively polymer crosslinking.

In the sterilization of blood plasma, medical instruments, packaging materials for medicine and food, such as e.g. vegetables, etc., using roentgen irradiation and electron irradiation is increasingly common. This takes place preferably using X-rays or electron beams since isotopes as radiation sources are dangerous and difficult to handle, and since alternative, e.g. chemical, sterilization methods are either not cost-efficient, or they may not be used for reasons of law. Industrial applications also include the drying of ink and polymer crosslinking with electrons (e⁻) in an energy range of 80-300 keV. In all applications, one aims for as high a dose rate as possible. The irradiation time can thereby be significantly shortened, which means a shorter throughput time and, with that, a reduction in costs.

The achievable dose rate differs fundamentally between X-ray emitters and electron beam guns. In the range up to 1 MV acceleration voltage, only 1% of the electron energy is converted into X-radiation for generation of X-rays. Of this, in turn, in standard X-ray tubes, less than 10% is used for irradiation, for reasons of geometry. There results from this a very small efficiency factor in the conversion of the electrical power into dose rate. When using electron beam guns, on the other hand, it can be assumed that at least 50% of the electron energy can also be used for sterilization. About 50% of the energy gets lost in the exit window. X-ray tubes and electron beam guns also differ in their application. Electrons have a low depth of penetration, and are thus suitable for sterilization of surfaces only. Using X-rays, however, materials can also be sterilized on the inside, but one must accept a poorer degree of efficiency.

For irradiation using X-rays, the dose rate per surface is determined by the distance of the object from the focal point of the radiation source and by the quantity of radiation generated at the focal point. This radiation amount is limited, for its part, by the thermal energy which must be dissipated or transported away through cooling of the focal point so that the material in the focal point does not melt. The specific dose rate of a conventional X-ray emitter is greatly limited by these two factors. To achieve a high dose rate, therefore, the object to be irradiated must come as close as possible to the radiation source. It can be necessary furthermore for the focal point of the emitter to be as large as possible so that the specific exposure at the focal point does not cause the target to melt.

With electron emitters, the object must also come as close as possible to the radiation source, since otherwise the electrons lose too much energy on the stretch of path through the air. With an optimized design of the exit window of the electron emitter, a relatively minimal portion of the radiating power gets lost in the anode (target), and thus a significantly higher dose rate is achieved with electron irradiation than with X-ray irradiation.

Thermionic electron sources have usually been used up to now as radiation sources. The thermionic electron source may be heated either directly or indirectly, and, with sufficient thermionic temperature, emit electrons (e⁻) directly into the vacuum of the emitter. Although the heated sources can be produced in a relatively reliable, robust and economical way, they suffer from some weaknesses.

Even though, as a rule, the heat output of the cathode amounts to only about 1-5% of the emitter power, measures for cooling in the cathode region are nevertheless to be taken with high current electron sources. Moreover the generator has to provide the heating power at high potential, which means high cost and a vulnerability to malfunctions. Since the thermionic electron sources have a high current density, they cannot be arranged surface-wise, but instead more point-wise. It is thus more difficult to irradiate evenly complex geometries as well. Thermionic electron sources are operated at high temperatures, at which the emitting material volatilizes already. Thus the service life of such sources is limited. Owing to current supply lines and possibly cooling, it is difficult to construct thermionic electron sources in such a way that they are transparent for X-rays. The geometric possibilities in irradiation are thus further limited.

With many applications of X-ray emitting sources, for example for sterilization purposes, a radiation source is required that achieves a high dose rate, and also makes possible an adaptation of the form of the radiation source to the shape of the respective object to be irradiated, and at the same time makes possible in particular irradiation of large quantities of these objects to be irradiated. Decisive for the cost-effectiveness of the irradiation method according to the invention is the integration of a cold cathode in the inventive irradiation device, for example in an X-ray tube or an electron beam gun.

The mode of operation of cold cathodes is to be described more closely in the following. Electrons (e⁻) are bound inside a solid body through a potential barrier. The potential barrier, also called work function ø, typically lies at 4.5 eV (electron volt) for conventional spiral-wound filaments of tungsten. With thermionic electron emission from the spiral-wound filament of the cathode, the electrons (e⁻) receive sufficient energy to overcome the potential barrier toward the vacuum. The thus achievable current density J of the thermoemission is

J=aT²exp(−ø/kT)

according to the so-called Richardson equation; a is thereby the Richardson constant, T the temperature and K the Bolzmann constant.

It follows from the Richardson equation that a lowering of the work function ø favors the thermoemission, and one tries therefore to work with other emitter materials such as tantalum, BaO, thorium, etc. Through the lower work function ø, it is possible to work at lower temperatures and consequently with lower volatilization rates and longer service life for the hot cathodes. Nevertheless the thermoemission has a high heating capacity requirement, owing to the high temperatures T which are needed (>1000° Kelvin), and thus high energy consumption. In conventional applications of the X-ray tube with a small filament, this is no problem. The voltage generators can additionally supply via the filament the required power with currents of 5 A at 8V impressed voltage. An upper capacity limit for the generators is reached at the present time as soon as more than three filaments are connected in series.

In contrast to thermoemission, with cold emission the potential barrier is deformed by an externally applied electrical field F, and assumes in first approximation a triangular form of height ø with thickness x=ø/eFₗ, e being thereby the charge of the electron (e⁻) and Fₗ being the local electrical field at the place of emission. If the barrier becomes sufficiently thin, i.e. when ø/eFₗ≦2 nm, the electrons (e⁻) are able to tunnel through the barrier and reach the vacuum; this is called cold emission or also field emission. To bring about an electron emission, very high field strengths Fₗ on the order of magnitude of 2-4000 V/μm are needed locally at the place of emission.

The current of a cold emitter may be expressed approximately using a simplified formula by Fowler and Nordheim 1928:

I=(1.5e−6 A(Fₗ)²/ø)exp(10.4/sqrt(ø))exp(−6.44e7ø^{1.5}/Fₗ)

A is thereby a prefactor to adapt experimentally determined currents, and sqrt ø—is the square root of the work function ø.

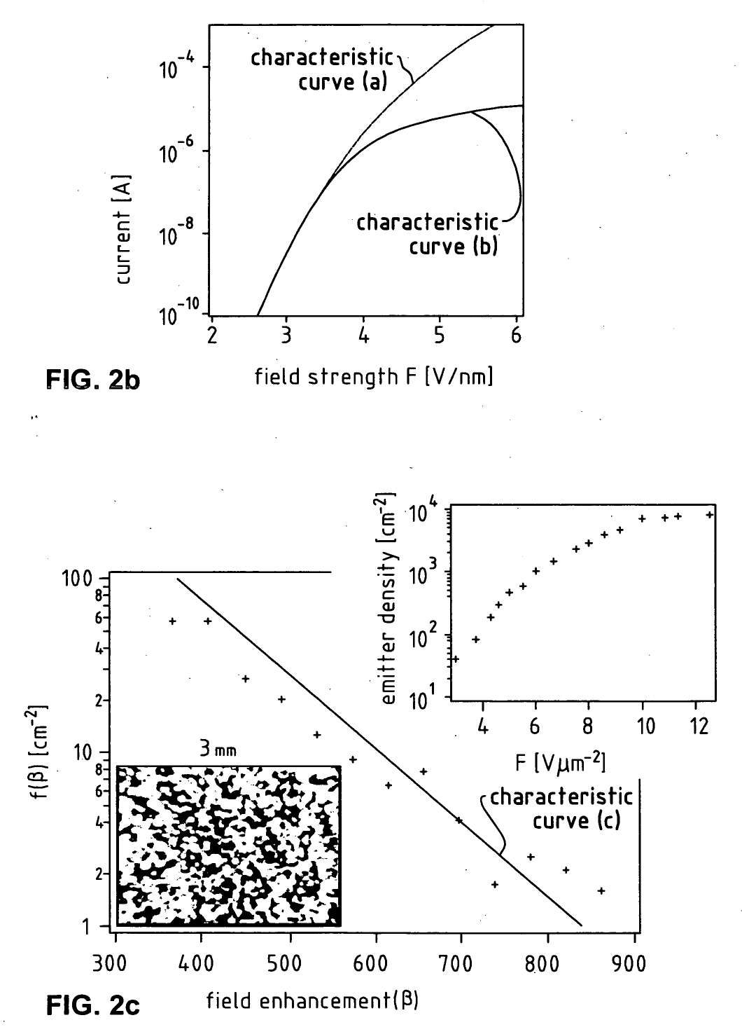

The typically very steep course of the characteristic curve of the current-field strength relation according to the formula of Fowler and Nordheim is illustrated in FIG. 2a <sic. 2b>. The locally enhanced field strength Fₗ at the place of emission then amounts to several thousand volts per micrometer. Such high electrical fields Fₗ are achieved through geometric field enhancement β. When an object capable of electrical conductivity having high length-to-width ratio β is brought into an electrical field, an electrical field enhancement at the tip will take place owing to the shift of charge, contingent upon geometry, in the object. If this object thereby has the height h and the radius of curvature r, there results approximately β=h/r. In first approximation, the strongly enhanced electrical field Fₗ may be expressed by the following equation

Fₗ=βF

whereby F is the externally applied electrical field. If, for example, the field-enhancing structures have dimensions of h=1000 nm and r=1 nm (this is possible e.g. with use of carbon nanotubes as field-enhancing structures, according to the invention), an electrical field enhancement is achieved, and thus cold emission of electrons with an impressed voltage, which voltage causes the externally applied field F, whereby the externally applied field F typically amounts to a few volts per micrometer, and the electrical field enhancement Fₗ amounts to a few volts per nanometer. The voltage necessary therefor is absolutely achievable technically.

To achieve a sufficiently high current density with a cold cathode, a high density of field-enhancing structures must be brought into the electrical field. Until just 30 years ago, this was hardly possible. In the last few decades, however, various microstructure methods have been developed, by means of which a density of up to 10⁸ emitting microtips/cm² can be achieved. Such a lithographically structured cathode is schematically represented in FIG. 2, and usually consists of metal tips, e.g. of molybdenum, and is known from flat picture screen technology.

The method of producing microtips with micrometer precision is elaborate and expensive. For this reason, the research results in the mid 1990s on cold emission of thin carbon films at extremely low applied electrical field intensities gave cause for a lot of excitement. At first it was assumed that responsible therefor were exceptionally low work functions ø of about 0.1 to a few eV. Today, with few exceptions, it is generally scientifically accepted that these carbon films are able to emit electrons efficiently, not because the work function ø is low, but because they also have field-enhancing structures. These structures may be located either on the surface or inside, in a matrix surrounded by insulating sp₃ phases. Designated as sp₃ is the strong covalent bonding in an electrically insulating diamond. For example, thin carbon films, grown in gas phase, can have micrometer-size, graphite-like sp₂ phases at the grain boundaries between insulating diamond-like sp₃ carbon. Since the electrical field applied can penetrate into this matrix, the graphite sp₂ phases act as field-enhancing structures. Carbon nanotubes are suitable for use as field-enhancing structures, such as described in the U.S. Pat. No. 5,726,524 B1, for example, but also other carbon types are commercially attractive, such as, for instance, coral-like carbon, which likewise has sharp structures on the surface, such as described in the U.S. Pat. No. 6,087,765 B1 and U.S. Pat. No. 6,593,683 B1.

The usual methods of the state of the art are conceivable for producing the carbon structures. For example, with precipitation out of the gas phase (Chemical Vapor Deposition—CVD), a carbonaceous gas mixture (for example, methane, acetylene, etc.) can be conducted into an evacuated reactor (vacuum recipient), often with H₂ (hydrogen), N₂ (nitrogen), etc., added. After that, either a microwave plasma is ignited, or the substrate heated to 600° to 900° Celsius. In both cases, dependent upon deposition parameters, different carbon structures grow on the substrate. Often catalytic growth is also used. A transition metal (nickel, cobalt, iron, etc) is thereby put on the substrate in the form of small clusters, i.e. only a few nanometers to micrometers in size. Carbon nanotubes are able to grow on these clusters. In the method referred to as “cathodic arc” in English, an arc discharge is ignited between two graphite electrodes in a helium atmosphere at current strength I of about ca. 80 A. After the discharge, found in the carbon black are nanotubes, which can be used after a cleaning procedure. The so-called laser ablation method can also be used, for example. Using laser, shots are thereby fired at a graphite target. Nanotubes are likewise found in the carbon black. By adding transition metals in the graphite target, single-walled nanotubes can be created. There exists a range of other production methods, or variants of the above-mentioned. It generally applies that one has a limited influence upon rates of defect in tubes, geometry of the tubes, rejects, etc. This has to do with the growth mechanisms being in fact little understood so far.

An important reason why, according to the invention, the use of carbon nanotubes in particular and other specifically structured carbon and its modifications as cold emitters is attractive, is the potential for cost-effective, large-area configuration of cathodes. But there are also other reasons why the use of carbon is interesting. Owing to the strong covalent bonds in carbon, cold emitters made of carbon are less prone to destruction than, for example, vapor-deposited molybdenum tips or etched silicon tips. The atoms in the high voltage field do not migrate, and have less the tendency to explode, as do metal tips, for instance.

It can be said that at the moment the methods of production of carbon nanotubes as electron emitters are not yet fully developed. Often the bonding of the tubes, for example with catalytically grown tubes, is very poor, and in the electrical field these tubes can be pulled off in the direction of the anode, owing to their charge (field-induced emitter destruction). The carbon nanotubes can thus, on the one hand, ignite electrical discharges, and, on the other hand, the emission performance becomes poorer over time. In fact, long-term stability of the tubes is unsatisfactory at the moment, and work is continuously being done to improve the bonding.

Another problem with use of carbon-based cold emitters relates to the limited emission current density of a large number of parallel emitting carbon structures on a flat plane. Actually, there typically are more than 10⁸ potential emitters per cm² on the average in a typical nanotube thin film layer. A well contacted nanotube should be able to transport without any difficulty a current up to 10 μA (theoretically even up into the mA range). That makes for current densities of 10³ A/cm² or more. Nevertheless the experimental values show that current densities of 1 to 100 mA/cm² and emitter densities of 10⁴ to 10⁵ emitters per cm², are achieved for electrical field strengths F of about 5-10V/μm (for higher field strengths, electrical discharges begin between anode-cathode in a disadvantageous way).

There are basically two explanations for this. On the one hand, a very high density of structures is disadvantageous for the field enhancement. With very short emitter-emitter spacing, an electrostatic shielding occurs, leading to a lowering of the geometrically enhanced field Fₗ.

On the other hand, a typical cold emitter film with carbon nanotubes has a stochastic distribution of field-enhancing structures. This leads in all experimentally studied cases to a spatially stochastic distribution β(x,y) of the field-enhancing structures on a cold cathode surface. Thus a statistical β-distribution may be defined as follows

f(β)=dn/dβ

dn being the number of field-enhancing structures per surface area in a small interval β to (β+dβ). f(β) is a measure of the performance or the efficiency of a cold cathode, and gives a quantitative description of the emitter-density and currency density via

emitter density(F)=∫f(β)dβ[cm⁻²]

current density(F)=∫f(β)I(β,F)dβ[Acm⁻²]

I(β,F) is the current of a single emitter as a function of the externally applied electrical field F, and the geometric field enhancement. It has been shown that f(β) for a typical cold cathode with carbon nanotubes has an exponential function of β, f(β)˜exp(kβ).

Owing to the relatively minimal number of efficiently field-enhancing structures in a higher β-range (>400), only a fraction of about 0.01% of all potential emitters consequently contributes to the current. The remainder of the emitters has too low a field enhancement value, and remains therefore passive, since the field Fₗ is smaller than 2 V/nm, see equation 2. The most efficient emitters, with a percentage share of 0.01%, do supply current at a low (i.e. with minimal voltage difference) applied field F, but since the number of these emitters is so minimal, the overall current density remains slight. An attempt to increase the externally applied field F, so that the less efficient emitters also contribute to the current, leads unfailingly to electrical discharges or above all to current-induced emitter destruction of the most efficient emitters.

In principle, known in the state of the art are three approaches for improving the current density and emitter density. As a first approach, an attempt is made through controlled growth to control the emitter-emitter spacing or respectively the emitter geometry (height-radius of curvature ratio). This approach is known as the so-called “self organization” of the field-enhancing structures. The electrostatic shielding arising between the emitters can thereby be eliminated or reduced to a large degree. The geometrically enhanced electrical field Fₗ thus increases. As the second approach, an attempt is made to control and to manipulate f(β) through controlled growth. The exponential behavior of f(β) of a typical carbon cold cathode seems to be intrinsic, but by greatly increasing the gradient of the straight line of f(β), a larger number of emitters are brought into a high β range. Thus these emitters will also contribute to increasing the current density. As a third approach, the use of ballast resistors is known, and is applied already to microtips. If one or more emitters are connected in series to a resistor, e.g. in the form of a resistive film or layer, the emission deviates from the typical Fowler-Nordheim behavior. The larger the geometrically enhanced field Fₗ becomes, the more the current deviates from the F-N characteristic line.

This effect is exploited to suppress the current of the most efficient emitters. That sounds paradoxical, but in this way a current-induced emitter destruction of the most powerful emitters is prevented, and the electrical field applied from outside can thus be increased. In the thereby increased electrical field, also emitters with slighter β can thus contribute to the current density, see equation 5. Since these emitters occur in very large quantities, owing to the exponential behavior of f(β), the overall current density of the cathodes increases.

The object of the invention is therefore to overcome the above-identified drawbacks of thermionic radiation sources, and to propose an irradiation device with X-rays or electron beams using a high dose emitter with minimal power losses of the cathode, with the aim of diverse geometry and of being able to irradiate in large quantities at the same time. In particular an X-ray emitter should be proposed that enables a dose rate many times higher than conventional X-ray emitters. The percentage of usable energy converted into X-rays should also be increased, and a uniform distribution of the X-rays with respect to the surface to be irradiated and the depth of the material should be obtained. Furthermore the proposed device should also make possible a cost-effective irradiation, in particular for sterilization of different objects and the drying of ink and polymer crosslinking, especially on an industrial scale.

These objects are achieved according to the present invention in particular through the elements of the independent claims. Further advantageous embodiments follow moreover from the dependent claims and from the specification.

In particular these objects are achieved through the invention in that an X-ray tube is constructed with a cathode, which emits electrons (e−) in an interior chamber that is under vacuum, and a target, configured as an anode, for generating high dose X-radiation (γ), the cathode comprising at least one cold cathode, based on an electron (e−) emitting material with field-enhancing structures, the cathode and the anode being designed as a first and a second closed hollow body, and one hollow body being formed inside the other hollow body, and the cathode and/or the anode comprising a material substantially transparent for X-radiation (γ). An advantage of this invention is, among others, that e.g. the material to be irradiated can be placed inside the X-ray tube, whereby a concentration of the X rays and a considerably more powerful and more even irradiation can be achieved. A further advantage of this embodiment variant is, among others, that both a reflector or transmission emitter configuration can be built without special cooling devices for the cold cathode (except air convection).

In an embodiment variant, the field-enhancing structures may include e.g. carbon nanotubes, coral-like carbon, metal tips, silicon tips, diamond tips and/or diamond dust. Advantageously the field-enhancing structures emit electrons (e⁻) already at room temperature. In contrast to the hot cathodes known as thermionic electron sources, they do not require any heating capacity in order to emit electrons (e⁻) in the vacuum. Field-enhancing structures able to be integrated on the surface of the cathode bring about a cold emission of electrons (e⁻) through intensification of an externally applied electrical field. The mode of operation of the cold cathodes in based on an externally applied electrical field being enhanced on structures of pointed design, so that high electrical fields are created, typically e.g. on the order of magnitude of 2000-4000 volts per micrometer. In relation to the electron-emitting surface of the cathode, the anode may be designed e.g. small or in the same proportion. This embodiment variant has the advantage, among others, that the electron emission takes place at room temperature, and thus the device for heating the emitter is omitted. Furthermore the cooling of the immediate vicinity of the emitter is done away with. As another advantage, the service life of the emitter should be mentioned. Since the emitter is operated at room temperature, no deterioration takes place through ablation of the emitter material. Owing to current supply lines and possibly cooling, it is difficult to construct thermionic electron sources such that they are transparent for X-rays. The geometric possibilities for irradiation are thereby further restricted. X-ray tubes with cathodes and/or anodes transparent for X-radiation are therefore not able to be produced in the state of the art, or only with difficulty.

In a further embodiment variant, the X-ray tube is designed as cathode hollow cylinder with a coaxial anode hollow cylinder inside. This embodiment variant has the advantage, among others, that e.g. the material to be irradiated is able to be placed inside the anode hollow cylinder and can be irradiated directly through the X-radiation (the radiation goes inward—transmission emitter).

In still another embodiment variant, the X-ray tube is designed as an anode hollow cylinder with a coaxial cathode hollow cylinder inside. This embodiment variant has the advantage, among others, that e.g. the material to be irradiated is able to be placed inside the cathode hollow cylinder and be irradiated with a transparent cathode (the radiation goes inward—reflector).

In a further embodiment variant, the cold cathode comprises at least one support layer for holding the electron (e−) emitting material, the emission surface of the cold cathode being defined substantially by the shape of the support layer. One advantage of this embodiment variant is, among others, that almost any desired geometric configurations may be achieved.

In another embodiment variant, geometry and spatial configuration of the emission surface of the cold cathode is determined by the shaping of the support layer. One advantage of this embodiment variant is, among others, that the geometry of the irradiation unit may be adapted in a simple way to the requirements of the irradiation method.

In a further embodiment variant, the ratio of the surface of the cold cathode to the layer depth is large. One advantage of this embodiment, among others, is that the cathode is suitable for large-surface irradiation devices.

In still another embodiment variant, the shape and size of the radiation chamber of the X-ray tube is determined by the surface area and/or spatial configuration of the cold cathode and/or of the anode. One advantage of this embodiment is, among others, that the material to be irradiated can be irradiated from all sides simultaneously.

In an embodiment variant, the support layer comprises a matrix with embedded carbon nanotubes and/or carbon structured in a coral-like way. An advantage of this embodiment variant is, among others, that it becomes very economical for large-surface emitter devices. Carbon nanotubes are commercially available, and carbon structured in a coral-like way allows itself to be applied economically in a large-surface way. Owing to its strong covalent bonds, moreover, carbon is more resistant than metal tips to ion bombardment and electrical discharges. Carbon is able to withstand large emission currents.

In another embodiment variant, the first support layer of the cold cathode comprises at least one substrate with ceramic material or glass. One advantage of this embodiment variant is, among others, that the support material is cheaper, shapeable, and vacuum-suitable. Moreover, the weakening of the X-rays by these materials is relatively slight.

In an embodiment variant, the support layer comprises at least one resistive layer and/or conductor path layer. One advantage of this embodiment is, among others, that the emission current is able to be distributed evenly over the cathode surface. Thus the specific power is able to be distributed optimally on the anode, and local overheating thereby avoided.

In a further embodiment variant, the conductor path layer comprises a vapor-deposited copper layer. An advantage of this embodiment variant is, among others, that the copper has good electrical and heat-transfer characteristics. Other metals can likewise be employed to advantage.

In an embodiment variant, the electron (e−) emitting material on the support layer is disposed with a defined spacing side-by-side, back-to-back and/or adjacently. This has advantages, among others, related to production technique, since the extraction grid allows itself to be more easily constructed in flat geometries. Thus a multiplicity of such emitter modules may be assembled into a complex geometry for the emitter configuration.

In another embodiment variant, the cold cathode and/or the anode are constructed from at least two independent segments. The number of these segments and thus the length of this configuration is in principle selectable as desired. An advantage of this embodiment variant is, among others, that the emitter configuration allows itself to be assembled in a modular way.

In an embodiment variant, at least one extraction grid is disposed between cold cathode and anode. An electrical insulator, for example, can be disposed between cold cathode and extraction grid. One advantage of this embodiment variant is, among others, that the spacing extraction grid-cold emitter can be kept constant over the emission surface. The local variation in emission intensity can thereby be reduced. The use of an extraction grid can also possibly serve as protection against ion bombardment and electrical discharges.

In another embodiment variant, the anode has at least one coolant layer (KM), the coolant layer (KM) comprising a liquid coolant and/or a gaseous coolant (KM). One advantage of this embodiment variant is, among others, that the anode can withstand a higher specific electron intensity. Thus a higher dose rate can be achieved.

It should be stated here that, besides the X-ray tube according to the invention, the present invention also relates to a method for sterilization and/or irradiation by means of an X-ray tube according to the invention as well as to a compatible electron beam gun.

Embodiment variants of the present invention will be described in the following with reference to examples. The examples of the embodiments are illustrated by the following figures:

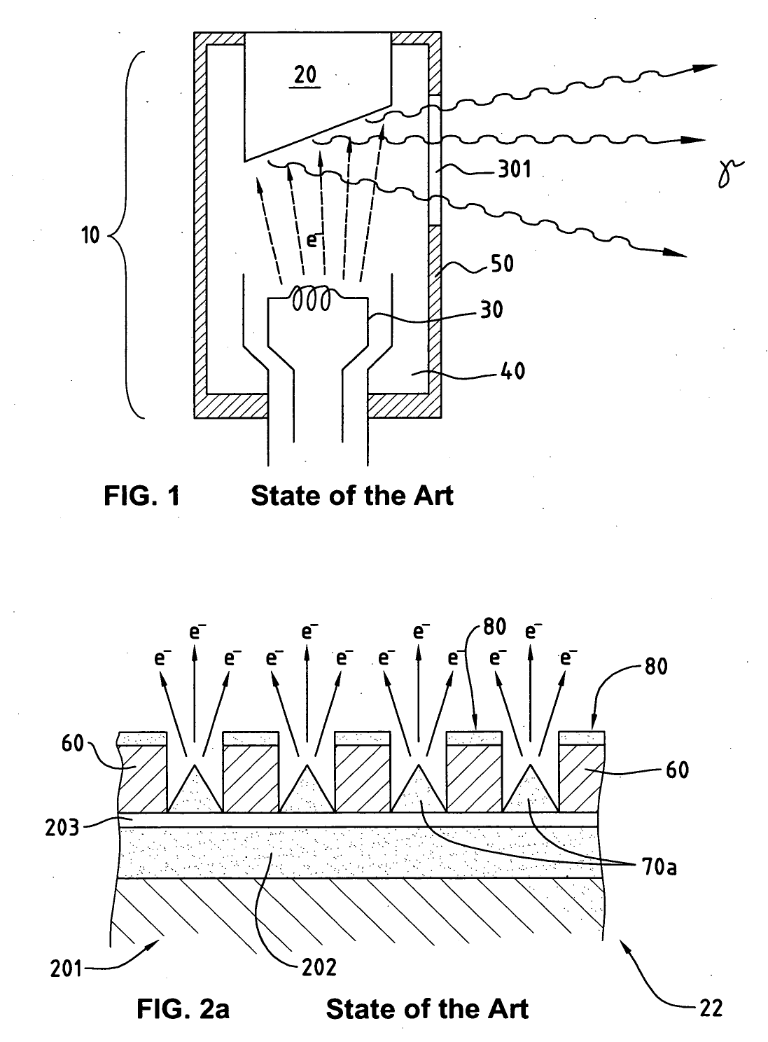

FIG. 1 shows an X-ray tube with thermionic electron source according to the state of the art. Electrons (e⁻) are thereby emitted by a cathode 30, and X rays 4 emitted by an anode 20 through a window 301.

FIG. 2 shows a cold electron (e⁻)-emitting cathode; shown schematically is a lithographically structured cathode with metal tips as field-enhancing structures of the state of the art.

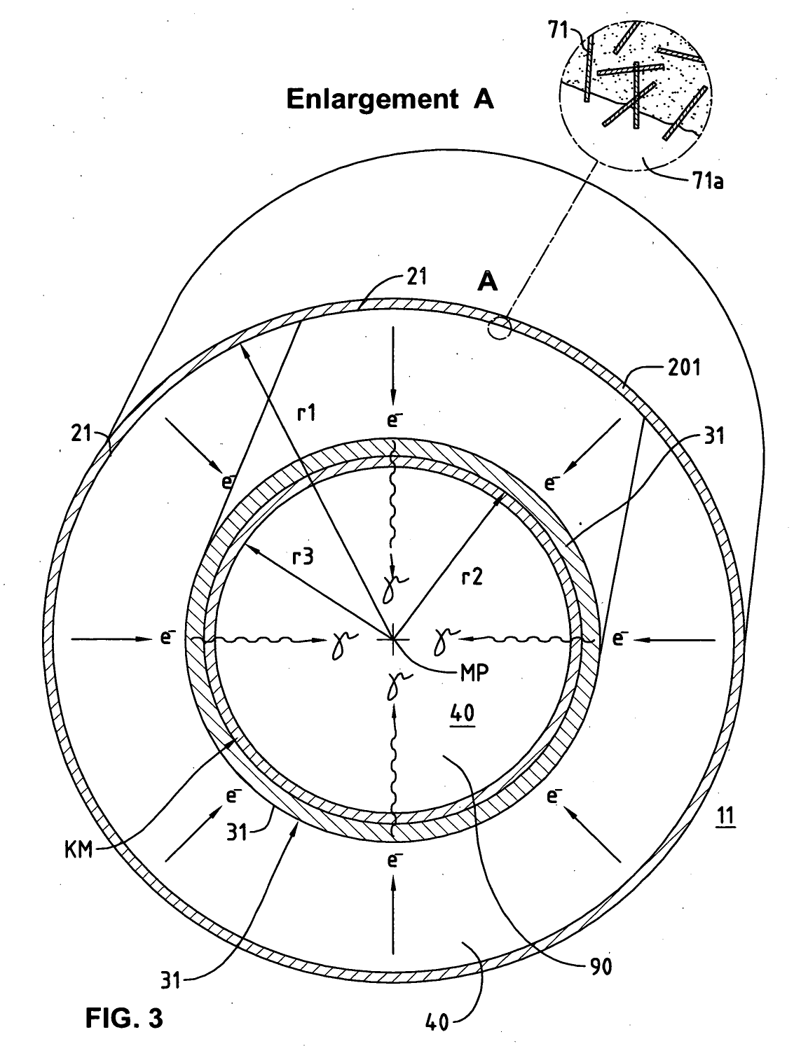

FIG. 3 shows a cross section of an embodiment according to the invention of an X-ray tube of hollow cylindrical shape; shown schematically in particular is the cross section through the hollow cylindrical cold cathode-anode-configuration, and the likewise constructed radiation chamber.

An evenly distributed 4π-gamma radiation, for example, can thereby be achieved inside the cathode hollow cylinder 31. The material to be irradiated can be placed inside the anode hollow cylinder 31. This ensures a uniform irradiation of the object from all sides, which would otherwise be hardly possible.

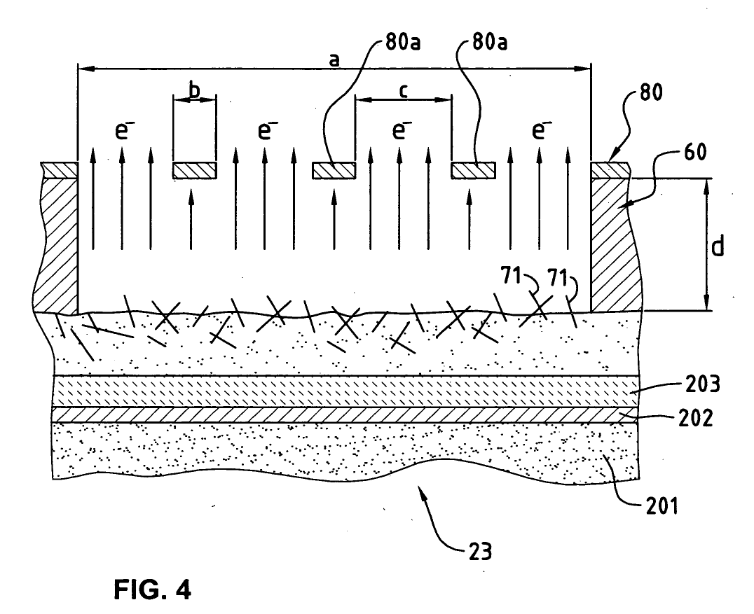

FIG. 4 shows the cross section of a cold cathode with carbon nanotubes with extraction grid in a so-called triode configuration of the electrodes.

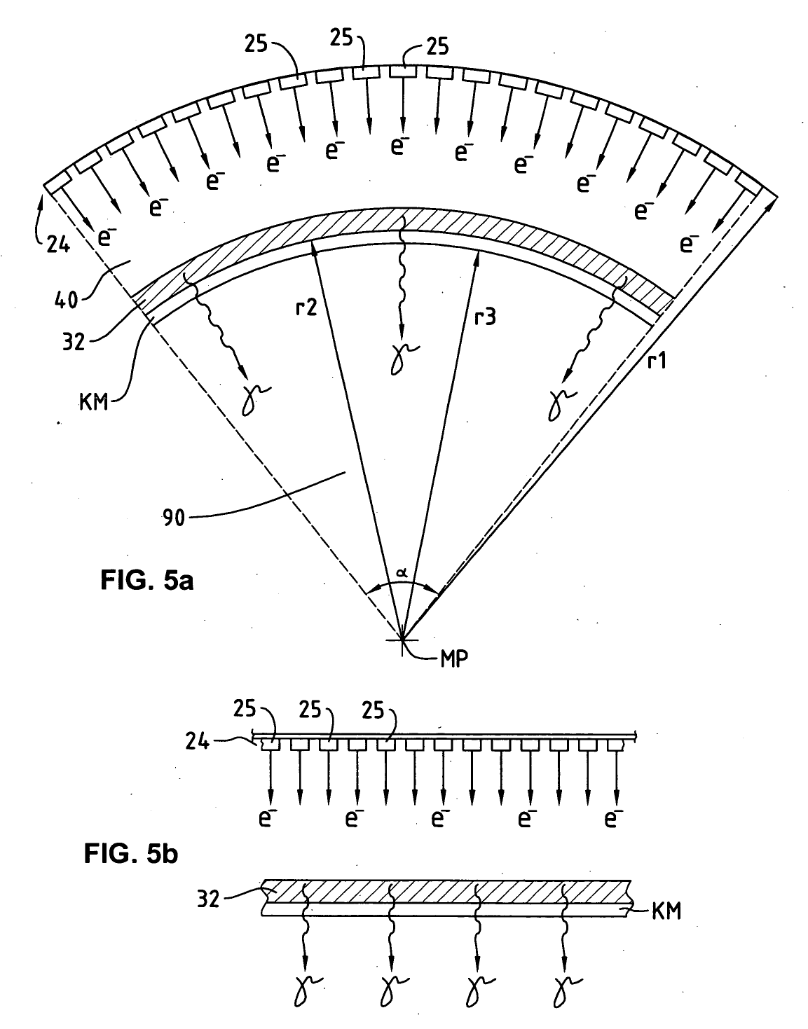

FIG. 5a shows the cross section of a transmission emitter configuration in variable electrode geometry with modularly assembled cold cathodes as electron sources in a circle segment portion. To achieve a 4π-gamma radiation (see also FIG. 3), a multiplicity of such transmission emitter configurations can be advantageously put together modularly. The prolongation of the transmission emitter configuration in the longitudinal direction, perpendicular to the paper plane, may be freely chosen.

FIG. 5b shows the cross section of a transmission emitter configuration according to FIG. 5a, with a special case of dimensioning of the cold cathode and anode radii, cathode and anode being disposed parallel or substantially parallel.

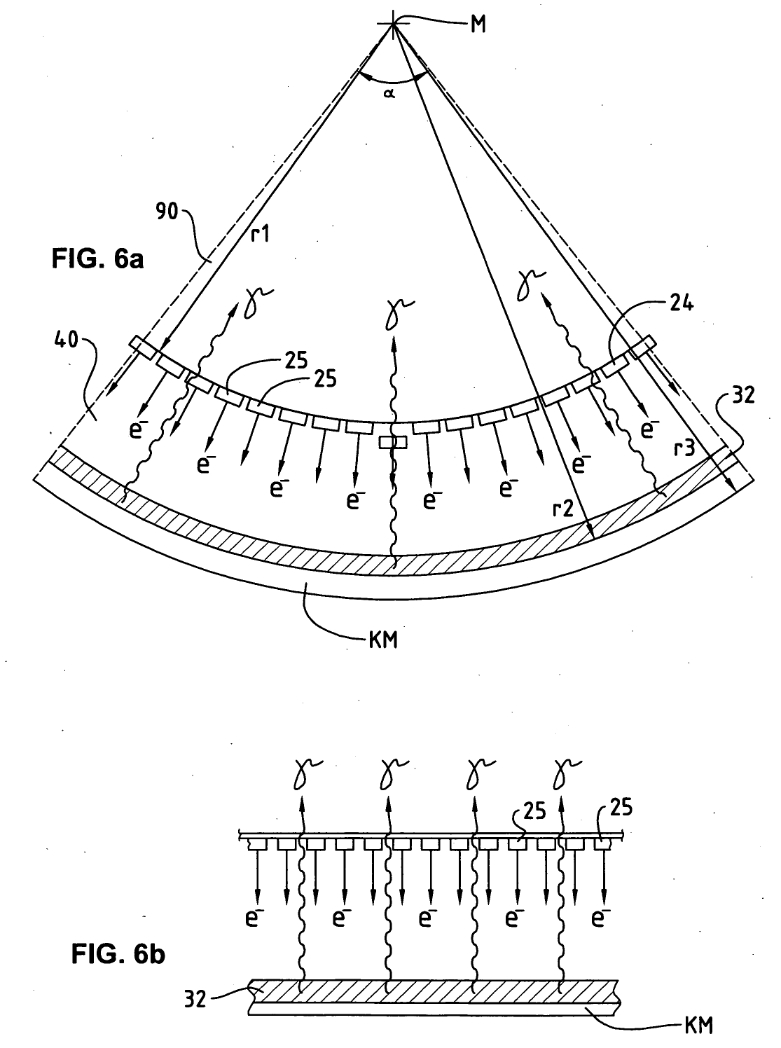

FIG. 6a shows the cross section of a reflector configuration in variable electrode geometry with modularly assembled cold cathodes as electron sources in a circle segment portion. The support layer of the cathode and the cold cathode are substantially transparent for X-radiation. The prolongation of the reflector configuration in the longitudinal direction, perpendicular to the paper plane, may be selected freely.

FIG. 6b shows the cross section of a reflector configuration according to FIG. 6a, with a special case of dimensioning of the cold cathode and anode radii, cathode and anode being disposed parallel or substantially parallel.

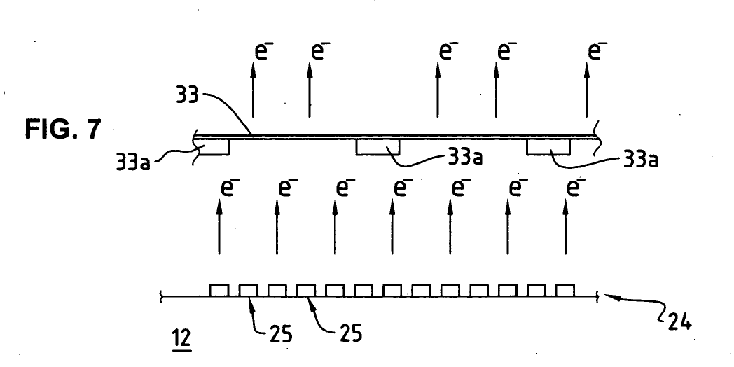

FIG. 7 shows an electron transmission emitter with modular cold cathode, in a configuration similar to FIG. 5b.

FIG. 1 shows schematically an architecture of such a conventional X-ray tube 10 of the state of the art. Electrons e⁻ are thereby emitted by an electron emitter, i.e. a cathode 30, as a rule a hot tungsten coil, accelerated to a target by means of an impressed high voltage, X rays γ being emitted by the target, i.e. the anode 20, through a window 301. That is to say, upon impingement of the electrons e⁻ on the target, X-radiation γ is generated in the then occurring focal point. The X-radiation γ exits through a window 301 into the outer space, and is used for irradiation purposes. Of the radiation generated on the target 20, only a small portion reaches the material to be irradiated. Most of the radiation is absorbed in the tube itself, for reasons of geometry. Thus, depending upon the size of the object, a particular irradiation spacing must be chosen in order to irradiate the object completely. In conventional configurations, typically only about 10% of the radiation in the half space of the target surface can be used. FIG. 1 shows an exit window 301 with an aperture of 50°.

FIG. 2 shows schematically a known lithographically structured cold cathode 22 of the state of the art. Vapor-deposited on an economical support, e.g. a ceramic substrate, is a conductive track layer 202; on this layer furthermore a resistive layer 203 is applied. Put on the resistive layer 203 as field-enhancing structures 70, also called (electron) emitters, are metal tips 70a made of molybdenum. The metal tips 70a are spaced apart using insulators 60, in each case disposed laterally adjacent. Applied on the surface of the insulator 60 in a form-fitting way is a gate 80, also referred to as grid, spaced apart in height, i.e. from the resistive layer 203 upward. An electrical field F (not shown) is applied between the metal tips 70a and the gate 80, which, functioning as an extraction grid, is made of a metallic material. The gate 80 is electrically (in an insulated way) and spatially separated, and has an aperture of typically a few micrometers. The difference in voltage between the gate 80 and the emitters 70a amounts typically to less than 100 volts. For applications in flat picture screens, for example, groups (pixels) of ten to several hundred such microtips 70a must be able to be energized in parallel. This is not absolutely necessary with X-ray tubes.

FIG. 3 shows in cross section the diagram of an X-ray tube 11 which, in a preferred embodiment, is constructed from a hollow cylindrical cold cathode 21 and a hollow cylindrical anode 31, which are disposed coaxial to one another. The common central axis of the two hollow cylinders runs through the common midpoint MP, as seen in the cross section of FIG. 3. Shown on an outer full circle with the radius r1 relative to the midpoint MP is the cold cathode 21 of the X-ray tube 11, in cross section. As shown extracted and enlarged in the diagram of the cut-out A, the cold cathode surface has a matrix with embedded carbon nanotubes 71a as field-enhancing structures. Emitted by the carbon nanotubes already at room temperature, as a result of the externally applied electrical field F (not shown), are electrons (e⁻) into the interior chamber under vacuum 40 of the X-ray tube 11. These electrons (e⁻) thus accelerated impinge upon the anode-side target 31, and cause, as is known, the emission of X-radiation (γ). Owing to the design of the anode 31 with smaller radius r2 with respect to the midpoint MP, the X-radiation (γ) is emitted into a likewise hollow cylindrically designed radiation chamber 90 on all sides. In the illustration of FIG. 3, a transmission emitter with a diode configuration of the electrodes 21, 31, is formed, using for the cold cathode 21 a support material which is not transparent for X-radiation (γ). Thus the full high voltage is impressed between the cold electron (e⁻)-emitting cathode 21 and the anode 31; in contrast to the other configuration, no extraction grid is disposed here. While the field-enhancing structures, in particular the carbon nanotubes 71, are embedded in a matrix 71a on the cold cathode surface, cf. enlargement A, the support material (not shown) of the cold cathode 21 consists, for example, of a low-cost ceramic substrate. This substrate closing off the X-ray tube 11 toward the outside, already forms the outer termination of the entire X-ray tube space, and encloses both the interior chamber under vacuum 40 as well as the radiation chamber 90 in a kind of double wall. In further embodiments (not shown), the support substrate is metallized outside, if need be, with a further layer, or comprises a further housing walling (not shown) of metal or also of a polymer substance. As shown in FIG. 3, with the use of cold electron (e⁻)-emitting cathodes 21, necessary is just a cooling of the anode surface. The cooling can take place with a liquid or gaseous coolant KM, such as water, oil or air, for example. The schematically shown coolant space, with a radius r3 (r3 smaller r2) going out from the midpoint MP of the common central axis of anode 31 and cold cathode 21, encloses jointly with the anode 31 the likewise hollow cylindrically designed radiation chamber 90. Used as material for the anode 31 in a known way is a metal with higher atomic number, e.g. tungsten. In the embodiment of the cathode surfaces described in FIG. 3, the carbon nanotubes 71, or also other field-enhancing structures 70 used, are exposed to the ion bombardment. Residual gases (also in low concentrations) can be ionized in the electron beam. They can thus contain energies corresponding to the fully impressed cathode/anode voltage (not shown) upon impingement on the cold cathode 21. However, owing to the strong atomic bonding of the carbon nanotubes 71, these can withstand the ion bombardment to a certain degree. In particular, the construction of an X-ray tube 11 with a round emitter transmission design, according to FIG. 3, of cold cathode 21 and anode 31 is interesting, for reasons of cost, since, without extraction grid or gate, the emitter configuration can be easily and economically produced. In particular, an all-over application of the field-enhancing structure 71 on a ceramic substrate is easily possible, production-technically.

FIG. 4 shows in schematic cross section the configuration of a cold cathode 23 with extraction grid 80; the anode belonging to the emitter configuration is not shown. First, a layer with conductive tracks 202 is vapor-deposited on a support material 201, e.g. an inexpensive ceramic substrate. The conductive track layer 202 serves to energize the individual field-enhancing structures 71 on the surface of the cathode 23. Inserted between the conductive track layer 202 and the field-enhancing structure 71 is a resistive layer 203, in series to the field-enhancing structures 71. According to the third approach already described above, this resistive layer 203 serves to improve the current density and emitter density as ballast resistor. The layers 201, 202, 203 are substantially transparent for X-radiation, and also resistant to the radiation. This means that the bonding, or respectively the electrical properties have long-term stability. As already mentioned, identified as another problem was in particular emitter destruction as a consequence of deficient bonding of the emitter on the cathode surface. Depending upon the circumstances, the emitter destruction can occur more through current- and field-induced destruction than through ion bombardment or electrical discharges. However, the deficient bonding of the emitter can have the negative consequence of an insufficient long-term stability of emitter performance. Consequently steps are to be taken to keep the long-term stability of the emitter performance constant; this is achieved by increasing the extraction voltage in a time-dependent way. To ensure an extraction voltage variable with respect to time, an arrangement of the electrodes in triode configuration, as shown in the diagram in FIG. 4, is especially advantageous. The extraction voltage (not shown) is impressed between the gate 80 and the cold cathode 23, and amounts typically 10 to 10 000 volts, depending upon the geometry of the field-enhancing structures 71 and the spacing between cathode surface and gate 80, the latter designated by arrow d. In the embodiment shown in FIG. 4, the field-enhancing structures 71 are less exposed to the ion bombardment and above all less exposed to the possible electrical high voltage discharges. The spatial and electrical separation of the gate 80 from the surface of the cold cathode 23 entails additional effort and thus also additional costs. The electrical/spatial separation takes place using an insulator 60, whose height or respectively thickness corresponds to the spacing (arrow d) of the gate 80 to the surface of the cold cathode 23. Like the cold cathode itself, for example, the insulators/spacers 60 can also be designed flat, and can have the shape of a perforated glass or ceramic plate, for instance. Each spacer 60 thus consists of a little glass rod, for example, which is cost effective especially with large-surface design of the cold cathode. As gate 80 (also referred to as extraction grid), a metal can be vapor-deposited, for example, on the front side of the insulator 60 remote from the cathode surface. A metal grid can also be used furthermore as the gate 60 <sic. 80>, with variable hole spacing, indicated by arrow c in the cross section of FIG. 4, and variable partition width (web between holes), indicated by arrow b in the cross section of FIG. 4. In implementing the triode emitter configuration according to FIG. 4, great importance must be accorded the geometry of the gate 80 (arrows a-d). The previously mentioned arrows b and c thereby determine the perforation pattern or respectively the web opening of the insulator 60; determined by arrow d is the spacing of the cathode surface to the gate 80, and arrow a determines the spacing between two insulators 60. Determined by the aforementioned values of measurement (arrows a to d) are power losses and the extraction voltage. The greater the shielding surface of the gate 80 towards the cathode 23, the surface for the spacers/insulators 60 being subtracted, the greater the losses will be at the gate 80. In an optimal design, therefore, the width of the grid partitions (web between holes) (arrow b) must be dimensioned as small as possible, and the web opening in the grid (arrow c) as large as possible. While the web opening in the grid (arrow c) cannot be dimensioned as large as desired, since otherwise the externally applied electrical field F (not shown) would be too small at the emitter site, the width of the grid partitions (web between holes) (arrow b) must be dimensioned sufficiently large so that the grid-shaped gate 80 does not become too greatly deformed owing to the electrostatic attraction. For the last-mentioned reason, it can be of advantage furthermore if a separate spacer/insulator 60 is disposed below each one of the grid partitions (web between holes) 80a. The spacing between two insulators (arrow a) hereby becomes exactly as large as the web opening in the grid (arrow c).

In a first design of the cold cathode 23 according to FIG. 4, for example, the following value ranges may be assumed: (i) spacing between two insulators (arrow a) 0.01 to 2 mm; (ii) width of grid partitions (web between holes) (arrow b) 0.01 to 0.2 mm; (iii) grid web opening (arrow c) 0.01 to 0.3 mm; (iv) spacing from the cathode surface to the gate (arrow d) 0.01 to 2 mm.

With large values for the spacing of the surface of the cathode 23 to the gate 80 (arrow d), a typical extraction voltage of several thousand volts must be worked with. The power losses at the gate 80 increase significantly as a result. With a spacing of the gate 80 from the surface of the cathode 23 amounting to some dozen μm, for instance, electrical extraction voltage of up to some hundred volts generally suffices, but, on the other hand, the risk of a short circuit of a not lithographically defined cathode is relatively great. Thus, in the design of the cold cathode 23, a compromise must be made with respect to said spacings, indicated by the arrows a, b, c and d. It is thus of further advantage to produce the cathode 23 using a lithographic method, defined gate, insulator and emitter surfaces in the micrometer range being used.

FIG. 5a shows a transmission emitter configuration with a modularly assembled cold cathode 24 consisting of a multiplicity of cold cathode modules 25 and an anode 32 in any definable circle segment for use according to the invention in an X-ray tube. Disposed on the outer segment section with the outer radius r1 are a multiplicity of cold cathode modules 25 with substantially the same spacing, as shown schematically. The cold cathode modules 25 have on their surface field-enhancing structures (not shown) which emit already at room temperature electrons (e⁻) in the interior chamber under vacuum 40 of the X-ray tube. Alternatively, the cold cathode module 25 could be equipped according to the embodiment variant in FIG. 4. Accelerated, the electrons (e⁻) impinge upon an anode-side target 32. As is known, X-radiation (γ) is hereby emitted by the target 32, e.g. into the radiation chamber 90. The anode-side target 32 is likewise disposed on a circle segment portion, however with smaller radius r2 with respect to the midpoint MP. The modularly constructed cold cathode 24 and the anode-side target 32 form a section of an annulus, this being variably definable, besides the radii r1 and r2, through the lateral delimitation and thus through the leg of the angle α, drawn in a dashed line. With a dimensioning of the angle α of 360°, a round transmission emitter configuration along the lines of FIG. 3 is formed, the respective number of cold cathode modules 25 is to be disposed on the outer annulus, without spacing apart. In principle, not only can the emission surface of the cold cathode 24 be assembled in a modular way, but also a multiplicity of transmission emitter configurations as shown in FIG. 5a, for instance four circle segment portion configurations with an angle of α=90° with the same outer cold cathode radius r1 and inner anode radius r2, can be put together to form a round transmission emitter configuration along the lines of FIG. 3. Basically, in the configuration of cold cathode modules 25 and of the anode 32 according to FIG. 5a, the angle of α is definable between 0 and 360°, and the radii r1 or respectively r2 are in any case to be dimensioned greater than zero μm, whereby, in using this arrangement, e.g. along the lines of FIG. 3, in an X-ray tube with a transmission emitter configuration, the difference of the outer cold cathode radius r1 to the inner target radius r2 determines the acceleration path of the electrons e⁻ and thus the internal space, e.g. to be put under vacuum, and the radius r2 determines the radiation chamber. A layer of coolant KM is indicated schematically by the further radius r3 (whereby r3 is to be selected to be smaller than r1 and r2) on the surface of the anode-side target 32, facing the radiation chamber 90. As already mentioned, advantageous in the design of a transmission emitter with cold cathodes is that cooling is necessary only anode-side.

Shown in FIG. 5b is likewise a transmission emitter configuration with a cold cathode 24 put together modularly. With a dimensioning of the radii r1, r2 and r3 towards the infinite, and the angle α towards 0°, which represents a special case of dimensioning according to FIG. 5a, the modular cold cathode 24 and the anode-side target 32 with coolant layer KM, are disposed parallel or substantially parallel to one another. With this configuration, emitter devices of a multiplicity of devices (X-ray tubes, electron beam guns) can be achieved in combination. For example, four emitters can be put together, each with an angle α of 90°, or only two emitters with a high radius of curvature r, or respectively a combination of the aforementioned emitter configurations. These emitter configurations may be constructed either according to the diode configuration already described in FIG. 3, i.e. without extraction grid, or in triode design according to FIG. 4, i.e. with extraction grid. If the individual cold cathode modules 24, with field-enhancing structures applied all over their surface, are put together without spacing apart, there likewise results a substantially overall emission surface of the combined cold cathode modules 25. With a combining of the cold cathode modules 25 having lateral, front and rear segments definable as desired, as indicated in cross section in FIGS. 5a and 5b, in a pearl necklace-like way, network-like structures are created of the surface of the modular cold cathodes 25, which are able to be defined as desired; the grid structure thereby depends on the form of the individually used cold cathodes 25 or respectively combinable cold cathode modules 24 and their arrangement. In principle, a modular construction of the anode-side target is also possible, in a way comparable to the modular design of the cold cathode 24; however, for reasons of cost, the anode is designed in one piece, as shown in FIGS. 3, 5a, 5b, which is easily achievable with respect to production technology, e.g. for applications with X-ray tubes of hollow cylindrical design of cold cathode and anode, or respectively in electron emitters with substantially coplanar arrangement of cold cathode and anode.

In a way comparable to FIG. 5a, FIG. 6a shows a configuration for a modularly constructed cold cathode 24 and anode, likewise in a segment of an annulus, definable as desired. In contrast to FIG. 5a, however, a reflector configuration is formed in FIG. 6a, a material transparent for X-radiation (γ) being used for the modular cold cathode 24, and the individual cold cathode modules 25 being disposed on an inner annulus with the radius r1 (toward the radiation chamber 90, for example as shown in an X-ray tube according to FIG. 3), and the anode 32 with coolant layer KM with radius r3 disposed on an outer annulus with the radius r2. Thus the radius r1 is dimensioned smaller than the radius r2, and this, in turn, smaller than the radius r3. When using a configuration of this kind, e.g. in an X-ray tube, electrons e⁻ are emitted at room temperature by the modularly constructed cold cathode 24, which electrons e⁻ are accelerated in the interior chamber under vacuum 40, and hit the target 32, X-radiation (γ) being emitted, in turn, from the anode-side target 32 in the radiation chamber 90, as a result. Through the cathode material transparent for X-radiation (γ) on the cathode side, the X-radiation (γ) reaches the radiation chamber 90, which is surrounded by the cold cathode 24 in this configuration.

FIG. 7 shows schematically an electron transmission emitter 12 with modular cold cathode 24, in a configuration along the lines of FIG. 5b, for use of the electron emitter 12 in an electron beam gun. Thus the anode-side material is designed permeable for electron beams, which is indicated in FIG. 7. With use of an electron transmission emitter configuration with modularly constructed cold cathode 24, the lost heat is transported away on the side of the anode 33, either through air convection, water or other special cooling. To construct the anode 33 to be transparent for electrons (e⁻), in particular a thin anode foil with support grid is to be used. The support grid partitions 33a are visible in FIG. 7. At energies in the range of 80-300 kV, the thickness of the anode foil typically amounts to 3-200 μm. The combination of the anode foil 33 with a support grid absorbs a portion of the incident electrons (e⁻), in particular the support grid itself. Under the condition that the foil, as described above, is sufficiently thin, and the ratio of grid partition width to grid opening of the support grid is small enough, the power loss is relatively minimal in the transmission window, and amounts on the average to less than 30% of the incoming power.

In principle, the above-mentioned proposed surface emitters and round emitter configurations or respectively transmission emitter and reflector configurations as well as the conventional emitter configuration in roentgen radiography can be constructed with a modularly assembled cold cathode and a correspondingly disposed anode. For applying the field-enhancing structures on the surface of the cold cathode, which substantially represents the emission surface for the electrons, all methods mentioned further above are suitable. The modular assembly of individual cold cathode elements as well as of emitter segments constructed therefrom is especially suitable for the large-surface design of flat and curved emission surfaces or irradiation surfaces. This way the construction of any desired geometry for the radiation chamber is possible as well as the arrangement of an emitter around any geometry for an irradiation object; high dose emitters can be disposed on the surface area, or respectively in the space, in an especially large-surface and definable way. It should be stated here that four basic configurations for the design of the emitter are possible:

1. Cathode inside, anode outside, radiation inward (reflector)
2. Cathode outside, anode inside, radiation inward (transmission emitter)
3. Cathode inside, anode outside, radiation outward (transmission emitter)
4. Cathode outside, anode inside, radiation outward (reflector).

While other configurations for the X-ray emitter are possible, only the configurations as transmission emitter may be considered for electron beam guns, in which a transparent anode always makes possible the passage of the electrons out of the vacuum space.

The advantages of the invention may be summed up as follows: besides a high dose rate, the cold cathode can be economically produced, in particular with overall application of the field-enhancing structures; the cold cathode has especially minimal thermal losses, and requires no additional cooling owing to its emission at room temperature; construction of a reflector or a transmission emitter is possible by using either cathode material transparent for X rays or cathode material not transparent for X rays. The combination of use of field-enhancing structures for a cold cathode and a defined cold cathode geometry by means of field-enhancing structures specifically in layer formation on a support layer, the defined development of further functional layers, and in particular the defined geometry of the contact surfaces between support layer and (e⁻)-emitting layer make <sic. makes> possible the construction in particular of a large-area-type or respectively modularly assembled cold cathode, and, with corresponding design of the anode, a large radiation chamber of freely definable shape. Partial irradiation on the object is likewise possible, e.g. through defined arrangement of individual cold cathode modules.

The advantages enumerated above apply for an X-ray emitter as well as for an electron beam gun. In the first case, the anode is designed such that all impinging electrons are absorbed and are used for generation of X rays. In the second case, the anode is designed such that the electrons substantially penetrate the anode, and can be used directly for irradiation.

### LIST OF REFERENCE NUMERALS

10/11 X-ray tube
12 electron emitter
20 cathode
21 cold cathode
22 cold cathode
23 cold cathode
24 modular cold cathode
25 cold cathode module
201 support
202 conductive track layer
203 resistive layer
30/31 anode
32/33 anode
301 exit window
40 interior chamber under vacuum
50 metal housing
60 insulator
70 field-enhancing structure
70a field-enhancing structure (emitter) made of molybdenum tips
71 field-enhancing structure (emitter) carbon nanotube
71a field-enhancing structure: matrix with carbon nanotube
80 extraction grid (gate)
90 radiation chamber
e⁻ electron emitter
γ gamma rays (X rays)
A cutout of the cold cathode surface
r1 radius of the cold cathode
r2 radius of the anode
r3 radius of the coolant layer
Arrow a variable spacing of the insulator
Arrow b variable spacing of the partition (web between holes)
Arrow c variable spacing of the hole
Arrow d variable spacing gate-to-cathode area
KM coolant
MP midpoint

1. An X-ray tube (11) with a cathode that emits electrons (e−) into an interior chamber (40) that is under vacuum, and with a target (31, 32), configured as an anode, for generating high-dose X-radiation (γ), the cathode comprising at least one cold cathode (21, 22, 23) based on an electron (e−) emitting material having field-enhancing structures (70), wherein
the cathode (20) and the anode (31, 32) are designed as a first and a second closed hollow body, one hollow body being formed inside the other hollow body, and
the cathode (21, 22, 23) and/or the anode (31, 32) comprises a support material substantially transparent for X-radiation (γ).

2. The X-ray tube (11) according to claim 1, wherein the X-ray tube (11) is designed as cathode hollow cylinder (20) with a coaxial anode hollow cylinder (31, 32) inside.

3. The X-ray tube (11) according to claim 1, wherein the X-ray tube (11) is designed as anode hollow cylinder (31, 32) with a coaxial cathode hollow cylinder (20) inside.

4. The X-ray tube (11) according to one of the claims 1 to 3, wherein the cold cathode (21, 22, 23) comprises at least one support layer (201) for holding the electron (e−) emitting material, the emission surface of the cold cathode (21, 22, 23) being defined substantially by the form of the support layer (201).

5. The X-ray tube (11) according to one of the claims 1 to 4, wherein geometry and spatial configuration of the of the <sic.> emission surface of the cold cathode (21, 22, 23) is determined by the shaping of the support layer.

6. The X-ray tube (11) according to one of the claims 1 to 5, wherein the ratio of the surface of the cold cathode (21, 22, 23) to the layer depth is large.

7. The X-ray tube (11) according to one of the claims 1 to 6, wherein the shape and size of the radiation chamber (90) of the X-ray tube (11) is determined by the superficial area and/or spatial configuration of the cold cathode (21, 22, 23) and/or of the anode (31, 32).

8. The X-ray tube (11) according to one of the claims 1 to 7, wherein the field-enhancing structures (70) comprise carbon nanotubes (71).

9. The X-ray tube (11) according to claim 8, wherein the field-enhancing structures (70) comprise coral-like carbon.

10. The X-ray tube (11) according to one of the claims 1 to 7, wherein the field-enhancing structures (70) comprise metal tips (70a).

11. The X-ray tube (11) according to one of the claims 1 to 7, wherein the field-enhancing structures (70) comprise silicon tips.

12. The X-ray tube (11) according to one of the claims 1 to 7, wherein the field-enhancing structures (70) comprise diamond tips and/or diamond dust and/or diamond-like carbon matrices of sp₂ and sp₃ bonded carbon.

13. The X-ray tube (11) according to one of the claims 1 to 12, wherein the support layer comprises a matrix with embedded carbon nanotubes and/or coral-like carbon.

14. The X-ray tube (11) according to one of the claims 1 to 13, wherein the first support layer (201) of the cold cathode (21, 22, 23) comprises at least one substrate with ceramic material.

15. The X-ray tube (11) according to one of the claims 1 to 14, wherein the support layer (201) comprises at least one resistive layer (203) and/or conductive track layer (202).

16. The X-ray tube (11) according to claim 15, wherein the conductive track layer (202) comprises a vapor-deposited copper layer.

17. The X-ray tube (11) according to one of the claims 15 to 16, wherein at least one electron (e−) emitting layer of the support layer and at least one resistive layer (203) are connected in series.

18. The X-ray tube (11) according to one of the claims 1 to 17, wherein the electron (e−) emitting material is disposed on the support layer with a defined spacing side-by-side, back-to-back and/or adjacently.

19. The X-ray tube (11) according to one of the claims 1 to 18, wherein the cold cathode (21, 22, 23, 24) and/or the anode (31, 32) are constructed from at least two independent segments.

20. The X-ray tube (11) according to one of the claims 1 to 19, wherein at least one extraction grid (80) is disposed between cold cathode (23) and anode (31, 32).

21. The X-ray tube (11) according to claim 20, wherein an electric insulator (60) is disposed between cold cathode (23) and extraction grid (80).

22. The X-ray tube (11) according to one of the claims 1 to 21, wherein the anode (31, 32) has at least one coolant layer (KM), the coolant layer (KM) comprising a fluid coolant (KM), and/or a gaseous coolant (KM).

23. An electron beam gun with an electron emitter configuration having an electron (e−) emitting cold cathode (21, 22, 23, 24) and an anode (33), a high-dose electron beam being generated, wherein the cold cathode comprises the characterizing features of at least one of the claims 1 to 23 <sic. 22>.

24. The electron beam gun according to claim 23, wherein the anode (33) comprises a very thin foil having a thickness between 6 to 200 μm with a support grid.

25. The electron beam gun according to claim 23 or 24, wherein the cooling of the anode (33) takes place by air convection, heat conduction and/or by a fluid cooling medium.
